(19) United States
(12) Patent Application Publication
(10) Pub. No.: US 2002/0149822 A1
(43) Pub. Date: Oct. 17, 2002

(54) Optical commuincation system for a portable computing device and method of use

(76) Inventor: Eric M. Stroud, Oak Ridge, NJ (US)

Correspondence Address: Eric M. Stroud, 146 Notch Road, Oak Ridge, NJ, 07438, US

(21) Appl. No.: 09/927,651

(22) Filed: Aug. 10, 2001

Related U.S. Application Data
(60) Provisional application No. 60/244,022, filed on Oct. 27, 2000.
(60) Provisional application No. 60/266,528, filed on Feb. 5, 2001.

(51) Int. Cl. H04B 10/00

(52) U.S. Cl. 359/154

(57) ABSTRACT

An optical communication system is provided for hand holdable computing devices. The optical communication system facilitates the data communication distance of the hand holdable computing device by using electromagnetic radiation between 200 nanometers and 1500 nanometers to pass data. The radiation is generated by the system using light emitting diodes or one or more lasers. The system is optically coupled to the infrared data communications port an existing hand holdable computing device or is electrically integrated into the computing device. Once coupled, the system allows the hand holdable computing device to communicate with remote optical communication devices up to 1000 meters away. The system finds application with personal digital assistants, cellular telephones, and portable computers.

### CROSS REFERENCE TO RELATED APPLICATIONS

This application claims the filing benefit under 35 U.S.C. §119(e) of U.S. Provisional Application 60/244,022, filed Aug. 14, 2000 and Provisional Application 60/266,528, filed Aug. 21, 2000 both of which are included herein by reference.

### TECHNICAL FIELD

The present invention is an optical communication system for portable hand holdable computing devices. The optical communication system consists of a co-packaged or removably connectable electromagnetic transmission and receiving components. The portable hand holdable computing device utilizes LASERs or light emiting diodes and optical detectors to establish high-speed data connectivity, permitting simplex or full duplex communications with remote optical devices.

### BACKGROUND OF THE INVENTION

The concept of utilizing the atmosphere to pass high-speed data signals is becoming an increasing viable alternative to the implementation of fiber optic or copper wire systems. Dramatic growth in the demand for broadband services, increased time and expense of deploying traditional fiber access, and heightened competition in the traditional copper wire markets are the driving forces behind the development of new broadband access technologies. Atmospheric optical networking is one of these broadband access technologies. Atmospheric optical networking is a network environment, which utilizes the atmosphere to pass signals, rather than fiber optics or copper-wire cabling.

The most problematic area for high-speed data networks is the “last mile”, that distance from the wide area network to the customer's premises. In the “last mile”, coaxial copper cables, fiber optics, or radio frequency receivers must be entrenched or installed at every customer's premise to give network connectivity to each customer from a city or town's local area network. Additionally, each city and town must be secured to a wide area network. The installation of these individual network connections as well as the local area network connections put a tremendous labor and material resource requirement on network companies and signal carrier companies.

There have been tremendous advances in bandwidth on either side of the cumulative area of customers and local area networks, termed the “local loop”. This has occurred from Dense Wavelength Division Multiplexing (DWDM), optical switching, Gigabit Ethernet and Fast Ethernet. Unfortunately, the benefits of these innovations have been dramatically reduced by slow local loop access between LANs (local area networks) and WANs (wide area networks). When optical networks are deployed in the atmosphere, the “first mile” from the LAN to the long-haul fiber network is no longer the ‘slow mile’, since the optical signal is derived directly from WAN or fiber network to the customer.

Atmospheric optical network services currently provide standards-based internet protocol (IP) connectivity directly through a customer premises' window using LASER (Light Amplification by the Stimulated Emission of Radiation) or LED (light emitting diode) receivers which can detect an atmospheric data signal. LASER light is most desirable for carrying data communications since it is both monochromatic and coherent radiation, and is easily modulated up to the high frequencies required for data transmissions. High-speed data rates, those greater then 9600 bits per second, can be achieved using modulated LASERs. LEDs approach monochromacity in their optical output, and usually have long operational lives.

Because an atmospheric network system liberates high bandwidth from fiber or cable, no trenching or building wiring is required to establish the service. The result is broadband connectivity to data, the Internet, and intranets that is quick to provision, highly scalable and much less expensive than fiber.

Included for reference here, “TeraBeam Networks, www.terabeam.com, constructed its first IP routed ‘Fiberless Optics™’, network in 1998. From 1998 to the present, TeraBeam has refined its technology and expanded its point-to-multipoint IP Metropolitan Area Network serving Seattle's urban core. Commercial service will be launched in summer of 2000 with the top national and international markets served over the next 3 years.”

### SUMMARY OF THE INVENTION

Other features and advantages of the present invention will become apparent from the following detailed description, taken in conjunction with the accompanying drawings, which illustrate, by way of example, the principles of the invention.

The present invention is directed to an optical communication system for increasing line of sight communication between a portable hand holdable computing device and a remote optical device.

The method includes the components necessary to enable a portable hand holdable computing device for line of sight atmospheric optical communication.

The method also includes the ability to establish high-speed optical data communications to a portable hand holdable computing device over line of sight distances.

A portable device which can communicate with remote optical devices through the atmosphere is particularly useful for a mobile user since the mobile user can synchronize, download, or upload pertinent information at very high transfer rates, typically greater than 9600 baud. The mobile user establishes communication with a remote optical device atmospherically by aiming their portable hand holdable computing device towards the remote optical device, such as an optical network node or beacon of an atmospheric optical network. The portable hand holdable computing device could first transmit information which indicates its presence on a network and then authenticates the user for access to the network. The mobile user, once authenticated, may select a particular function to execute, such as downloading the latest news, sports scores, or reading material. The mobile user may also upload personal information for storage and future use, such as appointments and personal calendar data. The mobile user may also synchronize information with other network participants, such as itineraries and mailing address data with team members or family members. In all events, the mobile user is required to aim their portable hand holdable computing device at a remote optical device, such as an optical network node or beacon site for only a short time, since data communication can take place at very high rates due to the extremely high bandwidth of an optical signal. Because of the extremely high bandwidth available, multiple portable hand holdable computing device users may, under certain configurations, simultaneously access the atmospheric optical network without noticeable degradation to transfer rates.

High-speed data communications typically involves two pairs of transmitters and receivers. Each site in the communication link possesses an electromagnetic transmitter and an electromagnetic receiver. The use of an electromagnetic transmitter and electromagnetic receiver allows for duplex or two-way communication amongst all parties involved in the communication system. Duplex communication schemes, such as high-speed Ethernet, IrDA (InfraRed Data Association), T1, E1, or TokenRing, may utilize a multiple wavelength receiver as well as a corresponding single or multiple wavelength optical transmitter. The eletromagnetic transmitter and receiver may be co-packaged into a single housing, or may be mounted in close proximity to each other at each point of the network or communication system.

The origin of a high-speed data signal transmitted through the atmosphere is typically a LASER or a LED. The LASER or LED is capable of being modulated in order to carry a data signal. Many types of LASERs are commercially available, including ion, diode, diode-pumped, and dye LASERs. Depending on the type of lasing medium used, one or more wavelengths of monochromatic coherent light is produced from a LASER. In the case of an argon ion LASER, many emission lines in the visible region of the electromagnetic spectrum are produced. The 488 nanometer emission line is useful because it is more pronounced in intensity than some of the other emission lines. Additionally, many types of LEDs are commercially available, ranging from subminiature “chip” LEDs to ultraviolet LEDs.

LASERs which can operate in continuous wave mode, or CW, are most useful for high-speed data applications, since the beam is uninterrupted while lasing activity is occurring. The small size, CW operation and wide variety of emission lines of diode LASERs make this category of LASERs a practical solution for high-speed atmospheric data transmission. Quasi-CW and pulsed LASERs, such as Excimer, ruby, and doubled YAG LASERs exhibit beam “separations” or gaps while lasing due to very short pulse discharges or flash lamp refreshing periods. These separations make such pulse LASERs inefficient for high-speed data use.

Some LASERs are capable of being directly modulated, as in the case of diode LASERs, while other LASERs may be modulated using piezoelectric optics. A diode LASER may be switched on and off very quickly, since no long periods of time are required for charging flash lamps or capacitor banks or pre-heating the lasing medium. The rapid on and off switching of the lasing activity enables a digital signal to be carried by an optical signal through the use of this LASER. Similarly, LEDs area also CW devices, and perform very well for high speed on and off switching.

The modulated LASER of LED signal may be optically corrected for brightness, divergence, or effective area. When a modulated LASER or LED signal is intended to be used in a precise point to point communication link through the atmosphere, the LASER or LED beam may be very tightly collimated, or focused, such the beam diameter does not diverge or expand during propagation. When a modulated LASER of LED signal is intended to be received by multiple remote optical devices, such as in a simplex broadcast, the beam may employ no or little collimation, such that the beam diameter becomes increasing large over a short distance.

The LASER or LED at a fixed remote optical device or network node is typically located at a “beacon” site, which is located at a relatively high elevation, such that its optical signal is line-of-sight, or within visible range of the optical communication system. Line-of-sight distances are typically between 0 and 20,000 meters to the horizon, although optical signals may be propagated atmospherically over many thousands of meters. A skyscraper, tall office buildings, radio transmission towers, residential apartment buildings, or in some cases, telephone poles or trees may be utilized as optical beacon sites. A beacon site is also chosen to maximize eye and fire safety and for the least optically unobstructed path for the receiving community.

The modulated LASER signal leaves the beacon site and is propagated atmospherically to one or more users with portable hand holdable computing devices. These network users are within the line-of-sight distance of the beacon site. Co-packaged within, or removably connected to the portable hand holdable computing device is an electromagnetic receiver consisting of one or more gathering optics and one or more electromagnetic receivers. The receiver is sensitive to the 200 nanometer through 1500 nanometer portion of the electromagentic spectrum. One or more optical filters may be installed between the optional Agathering optic and the electromagnetic receivers.

The gathering optic is employed to collect as much light as possible and to focus it upon an electromagnetic receiver. The most suitable optic is a lens with a positive focal length. Positive focal length lenses include: Bi-convex lenses, which are thicker in the center that at the edges; Plano-convex lenses, which have one flat side and are thicker in the center that at the edges; Fresnel lenses, which employ concentric grooves on a flat, thin surface; or Achromatic lenses, which consist of multiple lenses and maybe be color corrected. One or more of these lenses may be employed as a gathering optic depending on the amount of light to collect, and the degree of focusing required. All lenses should possess high optical transmission, such that weak LASER or LED signals are not further weakened by absorption in the optical material of the lens. Common commercial optical lens materials that are suitable for atmospheric LASER or LED signal reception include quartz, acrylic plastic, Pyrex, Tempax, Suprasil, Herasil and borosilicate glass. The optical material must be chosen in order to gain the highest possible optical transmission for the LASER or LED wavelengths intended to be received.

An optical window may be positioned before the gathering optic, in order to protect the gathering optic. An optical window is a flat optical component which possesses high optical transmission and low optical aberration. Dyed plastic, flashed glass, quartz, sapphire, or Pyrex may be used to construct an optical window. An optical window is desired when the gathering optic is coated with chemical compounds that may be effected by moisture, extreme temperature changes, or fouling. An example is the use of a sapphire window ahead of a gathering optic has an anti-reflection coating for a visible wavelength.

In some designs, the gathered atmospheric signal may reach one or more optical filters. The purpose of the optical filter is to provide wavelength selectivity. Within the portable hand holdable computing device's electromagnetic receiver, an optical filter prevents sunlight, automobile headlights, street lamp emissions and other stray optical signals from reach the optical-electric detector. The optical filter may consist of one or more of the following: An interference filter, which is designed to transmit a very specific wavelength and reflect all others; A narrow band filter, which is designed to transmit a small region of the electromagnetic spectrum, and to filter all wavelengths outside of this region; A broad band filter, which is designed to transmit a larger portion of the electromagnetic spectrum than a narrow band filter, but excludes all other regions; A polarizing filter, which transmits light of a certain polarity and filters the opposing polarity; and Absorption filters, which limit the density of an optical signal. The optical filter stage must be carefully positioned near the focal length of the gathering optics to allow the collected light to be filtered and to allow enough filtered light to reach and illuminate the detection stage.

When high selectivity is required for a particular wavelength of LASER or LED light, multiple stages of optical filters may be employed in the receiver. If the origin LED is an ultraviolet type LED producing a 375 nanometer emission line and is modulated for data, the optical receiver may utilize a broad band deep-violet glass filter and a 375 nanometer interference filter after the gathering optics to ensure that only the 375 nanometer wavelength reaches the electromagnetic receiver. Further selectivity is provided after the signal is electrically converted, since the use of many optical filters becomes expensive and attenuates the optical signal at each filter.

In the aforementioned process, the atmospheric optical signal has been received through a gathering stage and may be passed through optional filtering stages of the electromagnetic receiver. The signal arrives at the optical-electrical or “opto-electric” detection stage of the receiver. The opto-electric stage is careful positioned near the focal length of the gathering optics and in the path of the filter stage, such that the active area of the detector stage is illuminated with the gathered light, or in some designs, filtered light. At this stage, the collected LASER or LED signal is focused onto one or more components that efficiently convert an optical signal to an electrical signal. These devices ideally possess small temperature dependence, high sensitivity, and very fast response times to an optical signal. Typical devices used for this purpose include: Photodiodes, which allow current to pass in one direction in the presence of an optical signal; Photovoltaic cells, which produce voltage and current in the presence of an optical signal; Photomultipliers, which utilize a cascading or avalanche effect of a photon to detect and amplify an optical signal; Phototransistors, which act as current switches in the presence of an optical signal; and Photoresistors, which limit current in the presence of an optical signal. Many devices may be grouped or packaged into a single detector housing commonly termed a detector array. One or more detector arrays may be employed in the detection stage of the receiver to increase signal reception.

Each photodetector should also be selected based on the wavelength to be detected, to ensure optimum sensitivity in that emission region. In the event that an infrared LASER signal near 1450 nanometers is intended to be received, a commonly used detector sensitive to the visible spectrum may not exhibit enough sensitivity to this wavelength, and should be replaced with an infrared detector.

The shielded electrical signal derived from the opto-electric stage is now transferred to systems within, or removably connected to, the portable hand holdable computing device which can demodulate, decode, or otherwise transform the electrical signal into a useful communication format for a computer or network device. Digital signal processors, electrical filters, preamplifiers, signal amplifiers, comparitors, discriminators, or any combination therein may be utilized to decipher the signal. These devices provide further selectivity of the transmitted signal. For example, an optical signal may be modulated with a subcarrier frequency of 1 gigahertz. Signal processors may be employed which only recognize an electrical signal from the optical receiver which possesses a 1 gigaherz subcarrier frequency. Further selectivity is provided using multiple signal processing stages, and may also include optical filtering ahead of the photodetectors for wavelength selectivity.

It is desirable in most situations to utilize a pre-amplifier in close proximity to each photodetector. Pre-amplifiers boost very weak electrical signals to levels which are more easy detected by signal processors. Sensitive pre-amplifiers are typically electrically shielded to prevent stray signals from being amplified and the limit the amount of electrical noise detected. The entire pre-amplifier assembly may be enclosed within the receiver housing, and the pre-amplifier outputs are terminated at the shielded coaxial connections at the rear of the receiver housing. Many stages of pre-amplifiers may be employed for a single photodetector to increase the detection of the electrical signal. Furthermore, pre-amplifiers may be cooled and temperature controlled to achieve lower noise figures on the amplified signal. This is readily accomplished using Peltier junctions or cooling fans in close proximity to the pre-amplifier to electrically cool the temperature sensitive components of the pre-amplifier.

In the aforementioned process, an atmospheric optical signal has been detected and converted by the portable hand holdable computing device. In order to establish duplex communications, the portable hand holdable computing device must produce optical transmissions back to the remote optical device. The transmission process back to the remote optical device is accomplished using an electromagnetic transmission component, co-packaged within, or removably connected to, the portable hand holdable computing device.

The electromagnetic transmitter produces a collimated or uncollimated coherent electromagnetic signal between the 200 nanometer and 1500 nanometer portion of the electromagnetic spectrum. The electromagnetic transmitter accomplishes this using one or more internal diode LASERs, diode-pumped solid state LASERs, high-intensity light-emitting diodes, LED arrays, diode LASER bars or arrays or combinations therein. These devices can be electrically powered using the same battery which powers the portable hand holdable computing device, or with an auxiliary power source, such as a second battery. LASERs and LEDs with low power requirements may also be powered using solar energy utilizing solar cells, which convert sunlight into available electricity onboard the portable hand holdable computing device. Internal diode LASERs, diode-pumped solid state LASERs, high-intensity light-emitting diodes, diode LASER bars or arrays or combinations therein are capable of producing coherent or nearly coherent light which is or is approaching monochromacity.

The electromagnetic transmitter is modulated using piezoelectric, mechanical, or electrical modulation techniques. Modulation is necessary to encode the continuous eletromagnetic signal with meaningful data. The speed at which data is encoded and subsequently transmitted can be measured by baud or bits per second. Internal circuitry is necessary within the portable hand holdable computing device to interface low-power data communication signals to the modulator. Circuits commonly termed “drivers” interface communication streams from the portable hand holdable computing device central processing unit (CPU) with circuits that activate modulators. Modulator circuits may require more power to function than what is available from the CPU. By having an interface with fast response time between the CPU and the modulator, the CPU is isolated from any high-current stresses or radio frequency interference while optical communication is taking place.

Piezoelectric devices suitable for modulation an optical signal for high speed data include acoustic-optical modulators, known as AOMs, or polychromatic acoustic-optical modulators, known as PCAOMS. Both of these devices utilize an electric signal to drive a piezoelectric crystal, which subsequently blocks an optical signal or passes an optical signal, thus modulating the optical beam. Acoustic-optical modulators are compatible with any type of LASER to produce modulation. Piezoelectric devices typically require higher voltages, such as 28 volts, and an external oscillator to drive the crystal, such as an 80 MHz oscillator. The oscillator and driver circuitry is further interfaced to the CPU for transceiving data.

Mechanical devices suitable for modulation include galvometers equipped with highly reflective mirrors. Galvometers utilize an electric signal to mechanically position an attached mirror with great precision, thus directing the optical beam towards the output window of the personal digital assistant, or positioning the optical beam onto a beam block or material which prevents the transmission of light, thus modulating the beam at the output window. Galvometers equipped with proper mirrors are compatible with any type of LASER or LED to produce modulation by changing the angle of reflection. Galvometers typically require high current and driver circuitry to accomplish positioning and “braking”. The galvometer driver circuitry is interfaced to the portable hand holdable computing device's CPU for transceiving data, and this interface also isolates high current from the CPU.

Electrical devices suitable for high-speed data modulation include transistors, thyrectors, triggered switches, or optically isolated integrated circuit switches. These devices act as current switches, allowing high current to flow towards a solid state LASER or LED when a much lower current is applied to an internal gate or “trigger”. Low-power data signals from the CPU can be used to directly drive these gates. Electrical switching is compatible with only solid state LASERs, such as diode LASERs, diode LASER bars and arrays, LEDs, LED arrays, and diode-pumped solid state LASERs. These LASERs produce lasing action and a subsequent optical beam nearly instantaneously when current is supplied to the device. Electrical modulation is accomplished by applying a low-current modulation signal to the gate or trigger to rapidly switch the LASER between on and off states, thus producing modulation. These electrical switches may also be biased for precise optical output power to produce sideband and amplitude modulation schemes, where the LASER or LED operates at less than full output power until modulated, producing an increase in optical output power.

The rate of data transfer is a function of modulation. Data transfer rates cannot exceed the physical limitations of the modulator. High speed data transfer, greater than 9600 baud, is best accomplished using piezoelectric modulators or electrical switching rather than galvometric devices. Modulation speeds well exceeding 1 gigahertz can be accomplished using electrical switching, thus permitting data transfer rates of at least 1 gigabits per second, or 1,000,000,000 baud.

Communication paths between portable hand holdable computing device and line of sight remote optical devices are typically greater than 2 meters, so adequate optical power must be present within, or attached to, the portable hand holdable computing device to complete the atmosphere communication path. If adequate optical power is not available at the portable hand holdable computing device, each electromagnetic receiver at the remote optical device sites are required to have extremely high gain and sensitivity to detect the low power optical signal. Increased receiver gain and sensitivity requires additional and expensive optics and amplification circuitry, thus, it is more practical to employ high-power miniature solid state or diode LASERs or LED arrays within, or removable attachable to, each portable hand holdable computing device so that greater communication distance can be achieved. LASERs with optical power outputs ranging from 0.5 milliwatt to 1 watt are readily available for useage within or removably attachable to portable hand holdable computing devices. Output power in the 1 to 35 milliwatt range is suitable for short distance paths, ranging from 2 to 1,000 meters in the obstructed atmosphere, while output power in the 35 to 1000 milliwatt range is best suited for long distance paths, from 1,000 to 10,000 meters or more. LEDs with radiant optical output powers greater than 5 milliwatts are usually acceptable for communication paths between 2 and 1000 meters.

According to one aspect, the invention is a portable hand holdable computing device which can connect to and communicate with remote optical devices through the use of internal LASERs or LEDs, and optical detectors.

According to another aspect, the present invention is a portable hand holdable computing device capable of participating in atmospheric data transmission systems on wavelengths between 200 nanometers and 1500 nanometers, over distances between 2 meters and 1000 meters.

According to yet another aspect, the present invention is a portable hand holdable computing device capable of performing simplex and duplex data communications with remote optical devices.

Further details of the above-described method and system are set forth below in the discussion of the preferred embodiments, which should be read in conjunction with the accompanying drawings. As will be apparent from the description below, the method and system of the present invention and its variations are suitable for use with any portable hand holdable computing device utilizing LASERs or LEDs to communicate with remote optical devices over distances between 2 meters and 1000 meters in freespace on wavelengths between 200 nanometers and 1500 nanometers.

### BRIEF DESCRIPTION OF THE DRAWINGS

FIG. 1 illustrates a personal digital assistant with a removably connectable optical transceiver.

FIG. 2 illustrates a personal digital assistant with a co-packaged optical transceiver.

FIG. 3 illustrates how typical communications are accomplished between a portable hand holdable computing device and a remote optical device.

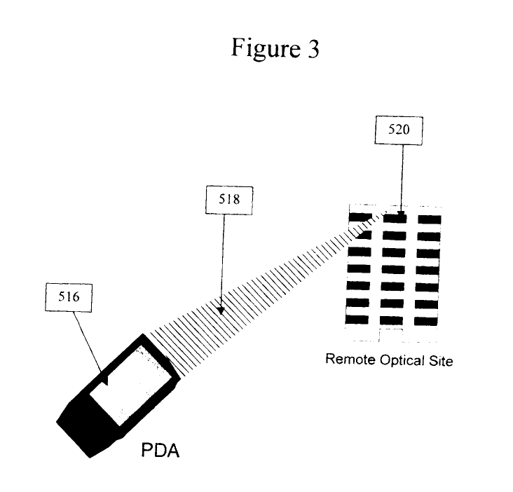

FIG. 4 illustrates how typical communications are accomplished between a portable hand holdable computing device and a wide area network.

FIG. 5 describes the external configuration of a portable hand holdable computing device with a co-packaged optical transceiver.

FIG. 6 shows the internal configuration of a co-packaged optical transceiver.

FIG. 7 illustrates the internal configuration of a portable hand holdable computing device with a removably connectable optical transceiver.

FIG. 8 illustrates the internal configuration of a removably connectable optical transceiver.

FIG. 9 shows the internal configuration of an electromagnetic receiver.

FIG. 10 shows the internal configuration of an electromagnetic transmitter.

FIG. 11 shows a tightly collimated optical signal originating from the portable hand holdable computing device with a co-packaged optical transceiver.

FIG. 12 shows a loosely collimated optical signal originated from the portable hand holdable computing device with a co-packaged optical transceiver.

FIG. 13 details the optical coupling mechanism for a removable optical transceiver.

### DETAILED DESCRIPTION OF THE INVENTION

The instant invention relates to a hardware system for the provision of a portable hand holdable computing device for line of sight communications. More particularly, the present invention is directed to, and concerned with, the transmission and reception of modulated light which carries voice, data, or both through the atmosphere. The optical communication system consists of internal transmission and reception components which allow optical communications to take place. The optical communication system provides the human user with a means to access and establish duplex communication with remote optical devices. Because high speed data transfer is possible using LASERs and LEDs, the human user is required to aim their optical communication system at a remote optical device for only a short time to transfer large volumes of data. The optical communication system extends increased communication range to the human user than conventional infrared, IrDA, dialup, or low-power radio frequency modems currently in use.

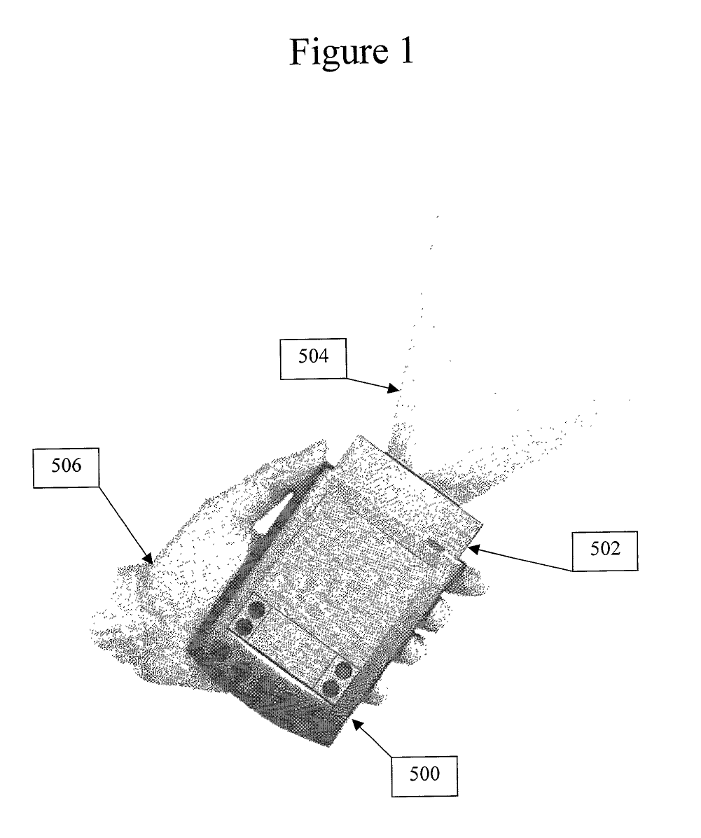

FIG. 1 illustrates a portable hand holdable computing device in the form of a PDA (500). A removably connectable optical transceiver is attached to the PDA (502) to allow line of sight optical communications (504) to take place. The entire device is portable enough to fit in the palm of one's hand (506).

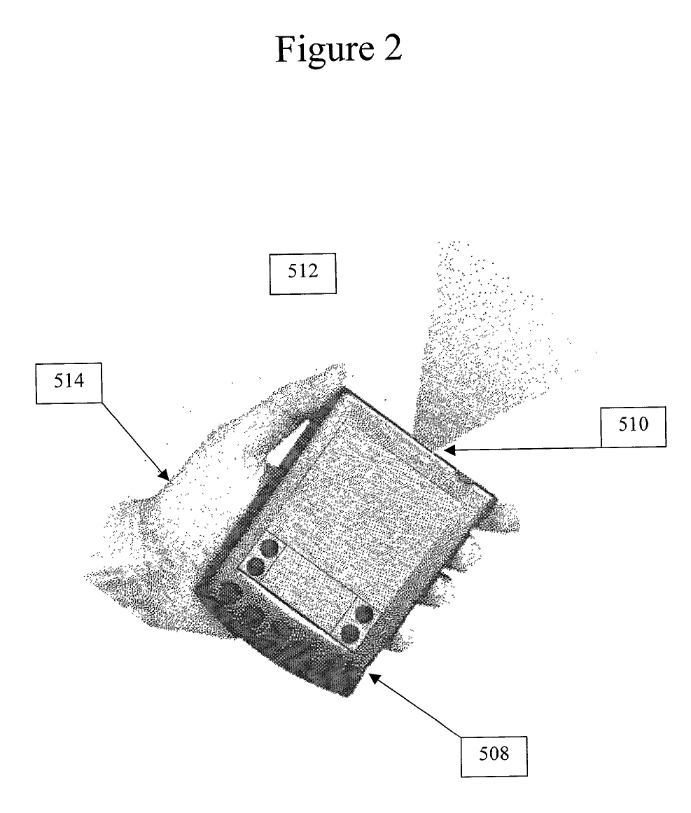

FIG. 2 illustrates a portable hand holdable computing device in the form of a personal digital assistant, or PDA (508). An optical transceiver is co-packaged directly with the PDA (510), allowing line of sight optical communications to occur (512). The entire device is portable enough to fit in the palm of one's hand (514).

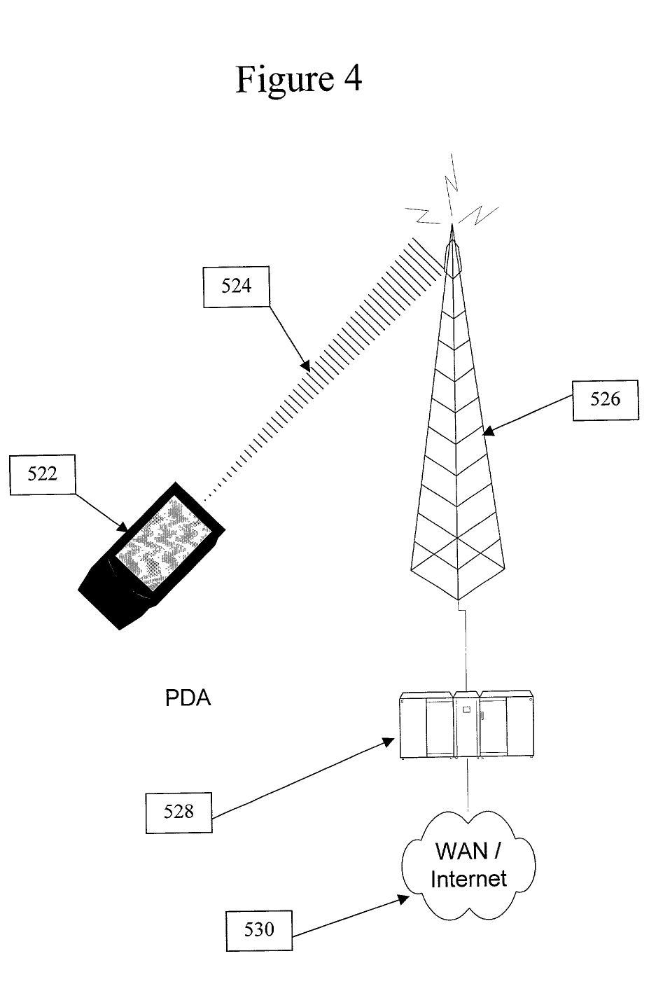

FIG. 4 illustrates the general configuration of a system linking a wide area network to an optical personal digital assistant. Data from a wide area network (530) is made available to the portable hand holdable computing device through the use of a remote optical transceiver mounted at an elevated vantage point (526) such that it is within line-of-sight distance to an optical PDA system (522). The optical PDA system establishes data communications with the wide area network by transmitting and receiving optical signals to the remote optical device site through the atmosphere between distances of 2 meters and 1000 meters on a particular electromagnetic wavelength between 200 nanometers and 1500 nanometers (524).

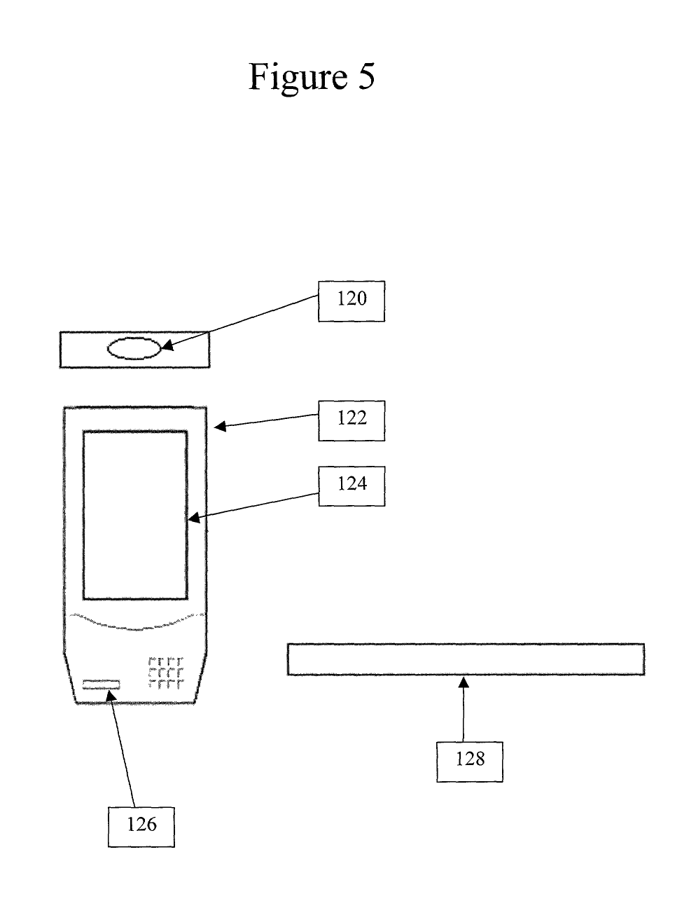

The illustration presented in FIG. 5 presents one preferred embodiment of the design of the co-packaged portable hand holdable optical computing device with the optical transceiver. The hand holdable device is in the form of a PDA. Observing the PDA from the front face, an aperture for an optical transceiver (120) is provided. The aperture contains optical components and may be protected with an optical window. The profile view of the integrated optical PDA (122) displays the large display screen (124) and data entry keys which are typical of any common PDA (126). The device is held by a human user such that the data entry keys (126) near the bottom of the device are closest to the human user. The optical aperture is positioned near the top of the device, from profile view, such that the aperture is pointed away from the human user. The flat side view (128) of the integrated optical PDA illustrates the compact design necessary to make the device portable enough to be readily transported by a human user.

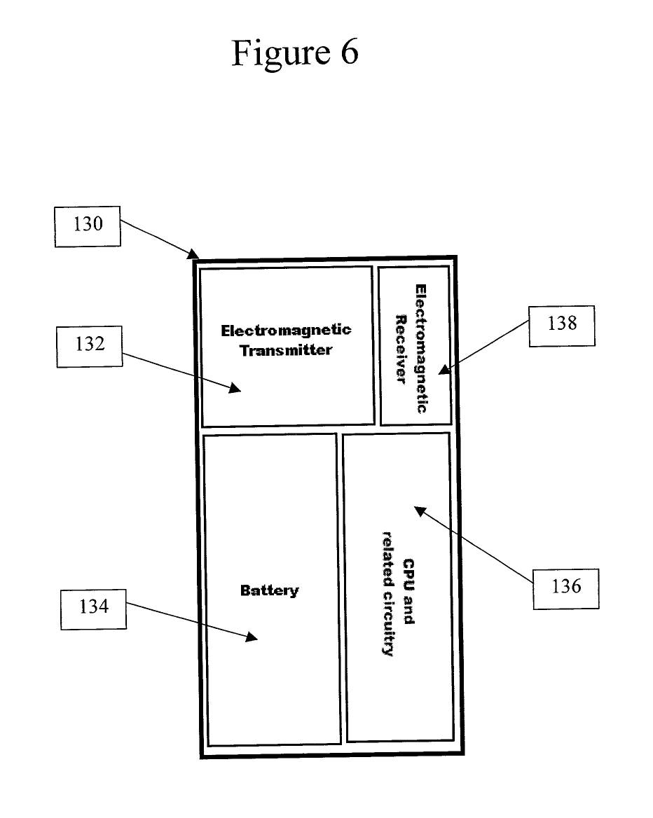

The illustration presented in FIG. 6 presents one embodiment of the internal component layout of the co-packaged portable hand holdable computing device with the optical transceiver. Observing the profile view of the entire device (130), the electromagnetic transmitter component (132) and the electromagnetic receiver component (138) are positioned near the top of the device, away from the human user's position. Adequate space is available for a power storage device (134) capable of powering the PDA's CPU, LASER or LED array, receiver, and related circuits. CPU and related circuitry may be mounted in the remaining space adjacent to the power storage device (136). Because of their minimized thickness, data entry keys, the display screen, and the display circuitry lays on top of or below the configuration presented in FIG. 6.

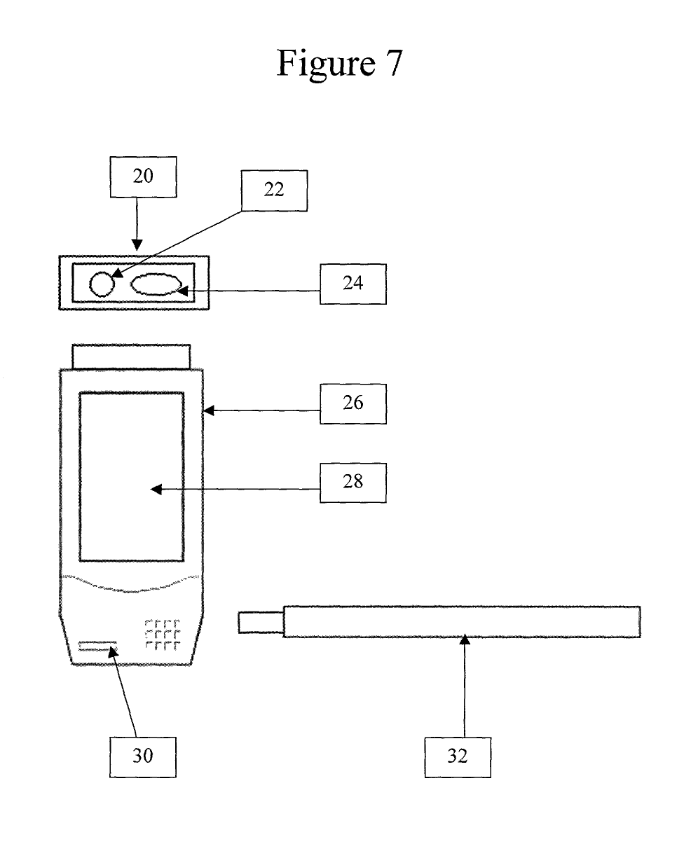

The illustration presented in FIG. 7 presents a preferred embodiment of the design of the removable optical transceiver for the hand portable holdable computing device. This embodiment interfaces to a PDA. Observing the PDA from the front face with the optical transceiver module (20) attached, an aperture for an electromagnetic transmitter (22) is positioned in close proximity to a second aperture for an electromagnetic receiver (24). Both apertures contain optical components and may be protected with optical windows. The profile view of the optical PDA system (26) displays the large display screen (28) and data entry keys (30) which are typical of any common PDA. A human user holds the device such that the data entry keys (30) near the bottom of the device are closest to the human user. The optical apertures are positioned near the top of the device within the removable communication module (20), such that the apertures are pointed away from the human user. The flat side view (32) of the optical PDA system illustrates the compact design necessary to make the device portable enough to be readily transported by a human user.

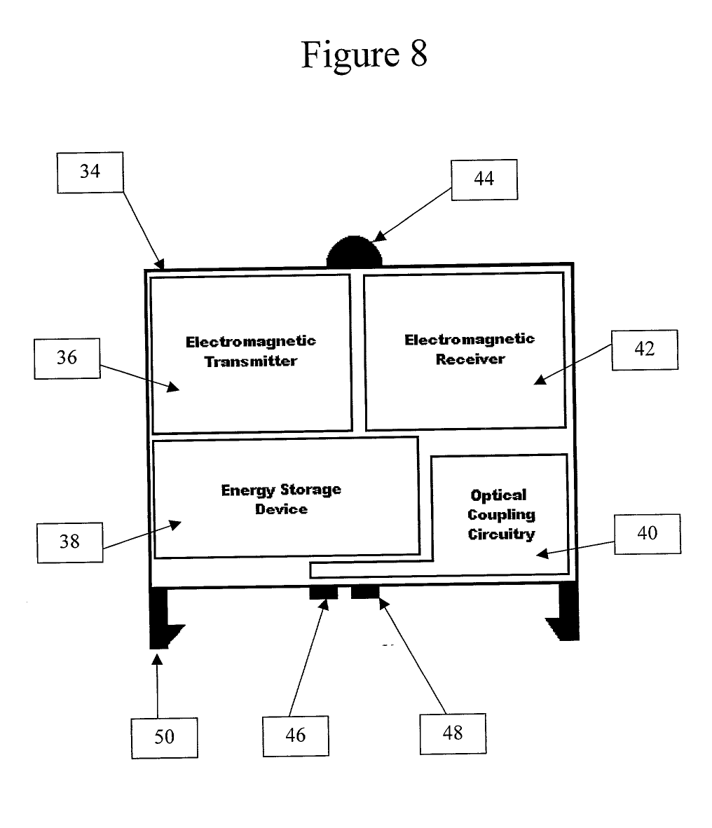

The illustration presented in FIG. 8 presents one embodiment of the internal component layout of the removable optical transceiver (34). Observing the profile view of the entire device, the electromagnetic transmitter component (36) and the electromagnetic receiver component (42) are positioned near the top of the device, away from the human user's position. Adequate space is available for an energy storage device (38) capable of powering the LASER or LED array, receiver, and related coupling circuits. An optical window (44) may be provided near the electromagnetic transmitter and receiver components of the module to allow for protection of delicate internal optics. Optical coupling circuits (46) are provided to translate infrared data protocols, such as IrDA, which are transmitted from the PDA's infrared port. A latch or securing mechanism (50) may be provided to securely fasten the communication module onto the PDA. Apertures for optical coupling are provided at the rear of the module. One aperture allows for the infrared transmission of data received from the atmosphere to the PDA (46) via a light emitting diode. The second aperture (48) allows for the infrared reception of data transmitted from the PDA to the module, via a phototransistor, which is internally used to drive the optical transmitter component. Both apertures may be protected by a single optical window.

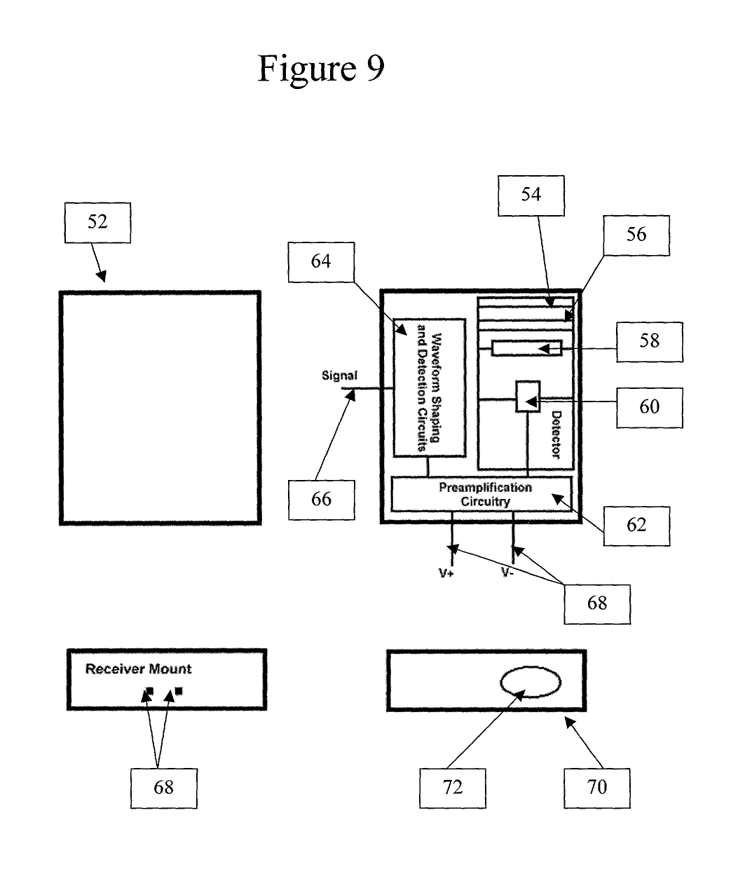

The illustration presented in FIG. 9 presents yet another embodiment of the internal component layout of the optical PDA system, specifically the electromagnetic receiver. The electromagnetic receiver may be enclosed or shielded to prevent external electrical and optical interference (52). A thin-walled tin metal box is adequate for electrical shielding as well as blocking all incident light. Viewing the receiver component's interior, an optical window (54) is present at the front wall of the enclosure, permitting light to enter the optical receiver stages. A gathering optic (56), such as a miniature fresnel lens, is positioned behind the optical window and focuses incident light onto an optical filter (58). The optical filter may be an interference filter centered on the electromagnetic wavelength of 670 nanometers, a wavelength commonly emitted from visible LASER diodes. The resultant filtered light terminates upon an optical-electrical detector (60). This detector may be a photocell, which is sensitive to visible wavelengths of light. The photocell converts the weak optical signal into a weak electric signal, which is inputted to sensitive pre-amplifiers (62). The pre-amplifiers increase the signal strength to a level useable by circuits following this stage. Amplified signals may be filtered, shaped, and compared to other reference signals using additional circuitry which is also shielded (64). The refined electrical signal (66) is then passed to the PDA's central processing unit as an input signal containing data collected from an optical beacon site. Direct current power to the entire receiver component is supplied by wiring connected to the PDA's power source (68). Viewing the receiver component from the front face (70), the optical aperture for the optical window, gathering optics, and subsequent optics is visible (72).

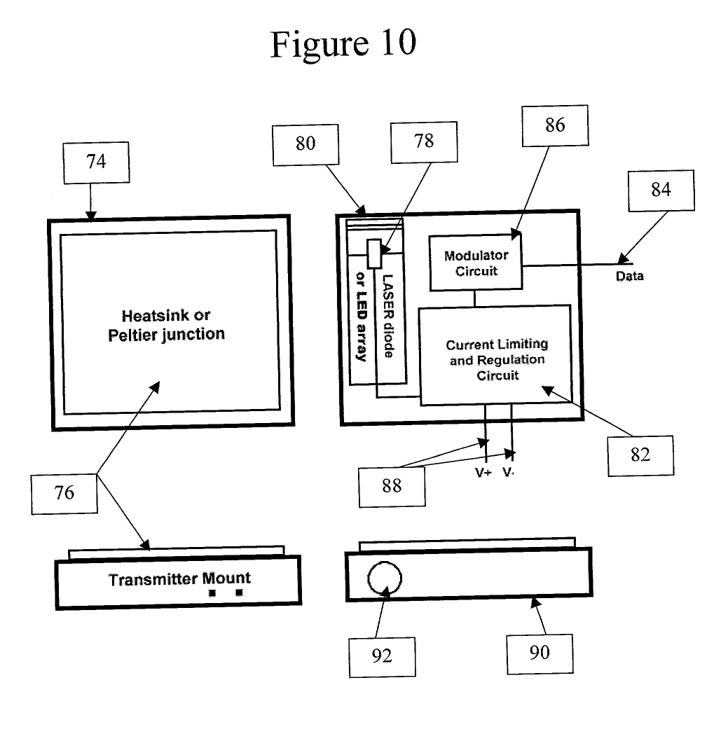

The illustration presented in FIG. 10 presents another embodiment of the internal component layout of the optical communication system, specifically the electromagnetic transmitter. The electromagnetic transmitter assembly may be encased or built within a solid, durable material which transfers heat efficiently, such as aluminum (74). Adequate heat transfer is necessary since the LASER or LED components generate wasted heat in the process of generating light which must be removed to prevent damage to the entire system. External devices such as a heat sink or electric junction coolers may be added to increase heat dissipation. Viewing the transmitter component from the side, a Peltier junction cooler (76) may be mounted upon the top surface of this enclosure (74) to increase cooling. Viewing the interior of the transmitter enclosure, a LASER diode or LED array (78) and a collimating optic (80) near its optical output are both mounted within the enclosure. The LASER diode or LED array derives its power from current limiting and regulation circuitry (82). The LASER diode or LED array is activated once a data signal from the PDA's CPU (84) actuates the modulator circuit (86), permitting regulated controlled power to flow to the LASER diode or LED array, resulting in an optical electromagnetic transmission. Direct current power to the entire transmitter component is supplied from the PDA's power source via wiring (88). Viewing the optical transmitter component from the front face (90), an aperture is present within the enclosure to allow the collimated and modulated optical signal to pass into the atmosphere (92).

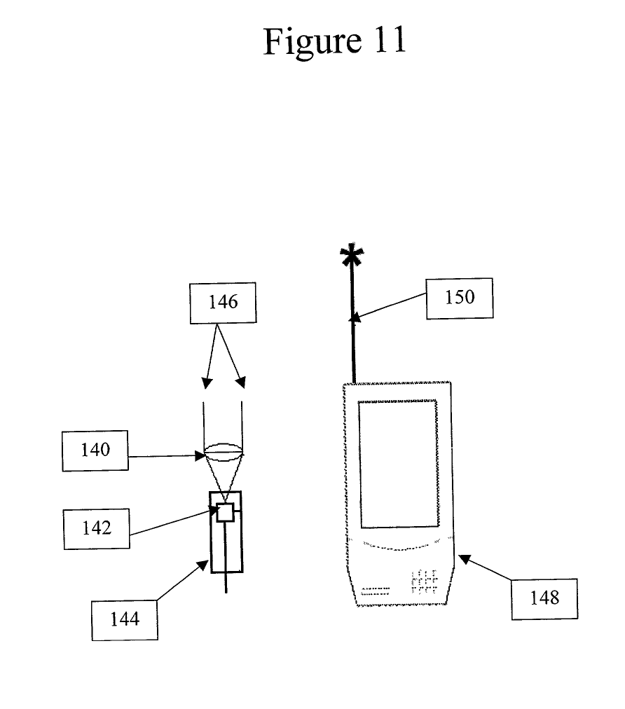

FIG. 11 illustrates a scenario in which the electromagnetic transmitter output is very tightly collimated, producing a thin beam of light. Tight collimation is particularly useful for overcoming long distances in the atmosphere, since most of the optical signal is directed onto a target. Producing a tightly collimated optical signal requires mounting a collimating optic (140) at the correct distance from the LASER diode or LED array output aperture (142). The collimating optic may have a focus adjustment and may be mounted within the housing for the LASER diode (144). Upon focusing the collimating optic, the diverging beam produced by the LASER diode or LED array becomes nondivergent, and the resultant beam's divergence is noticeably minimized (146) as it travels through the atmosphere. As observed by the human user holding the optical PDA system with a co-packaged optical transceiver (148), a visible wavelength optical signal emerges as a thin beam of light (150) from the electromagnetic transmitter component, and the PDA is aimed at a remote optical device. The beam is only visible to the human user if enough scattering matter is present in the atmosphere, such as dust or fog, and the wavelength corresponds to the visible region.

Tightly collimated optical signals present many safety issues, especially eye and burn safety. Since most of the power of the LASER or LED array remains in an essentially fixed diameter of illumination even over long distances, the PDA user may accidentally blind other harm other nearby persons. Additionally, many government regulations prohibit the user of high-power LASERs around areas where people are present without special licenses or variances. Tightly-collimated LASER or LED beams also interfere with persons operating vehicles, such as automobiles and aircraft. For these reasons, tightly collimated optical signals may be best suited for low-power “eye-safe” LASERs or LEDs for long distances.

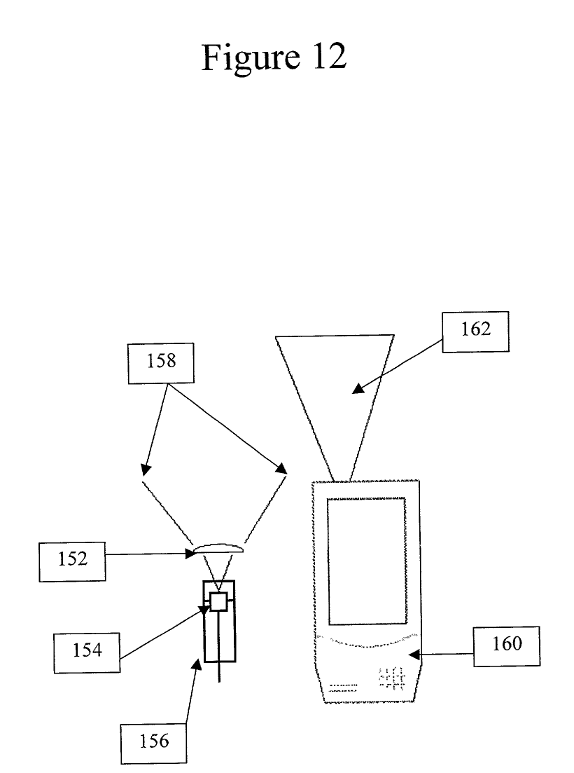

An alternative to tight collimation and low-power LASERs is loose collimation, where the beam is intentionally spread further as distance increases. The optical power is greatly reduced when measured at an increased distance from the LASER or LED. If accidentally pointed at a person's eyes, the full optical power of the LASER or LED is not focused onto the person's retina. Furthermore, since the optical power is spread over a very large area, the danger of skin burns and combustion is greatly reduced. As illustrated in FIG. 12, a diverging optic (152) is positioned at a correct distance from the output aperture of the LASER diode or LED (154). The diverging optic may have a focus adjustment and may be mounted within the housing for the LASER diode or LED (156). Upon focusing the diverging optic, the diverging beam produced by the LASER diode or LED increases in diameter, and the resultant beam's divergence is noticeably increased (158) as it travels through the atmosphere. As observed by the human user holding the optical PDA system with the co-packaged optical transceiver (160), a visible wavelength optical signal emerges as a wide cone of light (162) from the electromagnetic transmitter component, and the PDA is aimed at a remote optical device. The beam is only visible to the human user if enough scattering matter is present in the atmosphere, such as dust or fog.

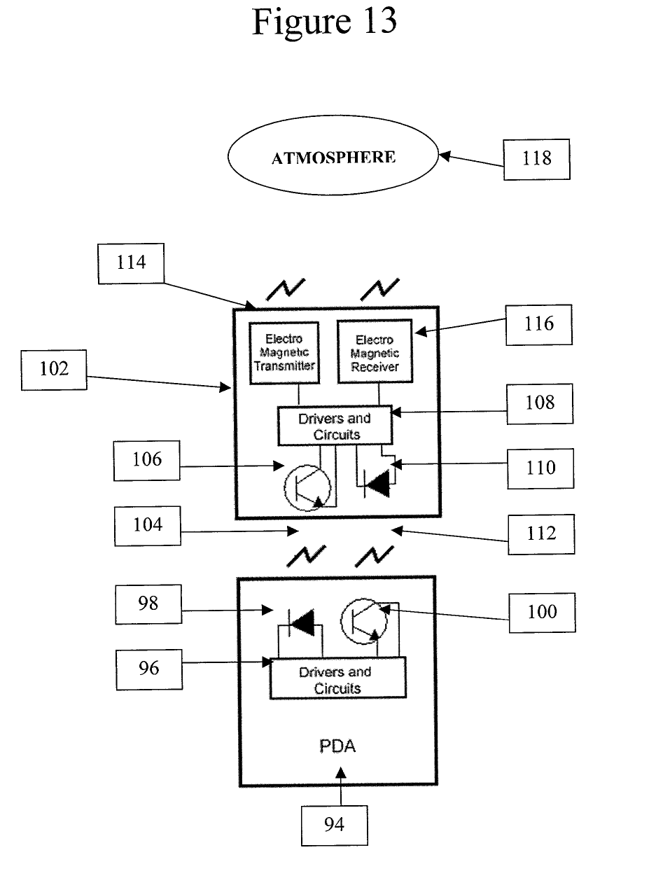

As illustrated in FIG. 13, optical coupling between the removably connectable optical transceiver and the PDA is accomplished using highly localized infrared signals. A PDA equipped with an infrared communication port (94) manages the transmission and reception of data via an internal infrared driver and interface circuit (96). This circuit drives an infrared light emitting diode (98), which in turn, transmits a modulated infrared optical signal through free space. The infrared driver circuit (96) also receives and interprets infrared signals received by an infrared phototransistor or photodiode (100). Optical coupling between a removably connectable optical transceiver (102) and the PDA (94) is accomplished over a very short distance in free space, typically less than one foot between the devices. Infrared signals are transmitted (104) to a corresponding infrared phototransistor or photodiode (106) within the removably connectable optical transceiver. These signals are then interpreted by an infrared data interface circuit (108) within the removably connectable optical transceiver. Conversely, the driver circuit (108) within the removable communication module may also actuate an infrared light emitting diode (110), transmitting a modulated infrared signal (112) to a corresponding phototransistor or photodiode within the PDA (94). The infrared driver and interface circuit within the removably connectable optical transceiver in turn actuates the electromagnetic transmitter (114) whenever data is received at the internal phototransistor or photodiode (106). This transmits an optical signal into the atmosphere for reception by a remote optical device. Conversely, an optical signal received from the atmosphere (118) by the removably connectable optical transceiver is intercepted and processed by the internal electromagnetic receiver (116), which communicates with the internal driver and interface circuit (108). When data is present at the electromagnetic receiver (116), the driver circuit (108) actuates an internal infrared light emitting diode (110), transmitting data back to the PDA (94).

I claim:

1. An optical communication system for increasing line of sight communication between a portable hand holdable computing device and a remote optical device, the computing device having a central processing unit, an electromagnetic transmitter, and an electromagnetic receiver, said optical communication system comprising:
(a) transmitting elements including:
(1) an electromagnetic receiver unit for receiving data from the computing device central processing unit via the computing device electromagnetic transmitter;
(2) an electromagnetic transmitter operating between any wavelength of 200 nanometers and 1500 nanometers for generating a light beam containing the data received from the computing device;
(b) receiving elements including:
(1) an electromagnetic receiver operating between any wavelength of 200 nanometers and 1500 nanometers for converting an optical data signal received from the remote optical device to an electrical signal;
(2) an electromagnetic transmitter unit connected to said electromagnetic receiver for transmitting the electrical signal to the computing device central processing unit via the computing device electromagnetic receiver; and, said communication system removably connectable to the hand holdable computing device.

2. An optical communication system according to claim 1 wherein the computing device is packaged in a first housing, further including:
said optical communication system packaged in a second housing, said second housing removably connectable to the first housing.

3. An optical communication system according to claim 1 wherein the computing device electromagnetic transmitter and the electromagnetic receiver include an infrared port, said communication system further including:
said electromagnetic receiver unit and said electromagnetic transmitter unit optically communicating with the infrared port of the computing device

4. An optical communication system according to claim 1, the computing device including an encoder disposed between the central processing unit and the electromagnetic transmitter and a decoder disposed between the electromagnetic receiver and the central processing unit, the encoder and decoder being IrDA compatible, said communication system further including:
a decoding unit disposed between said electromagnetic receiver unit for decoding the data received from the computing device, said decoding unit being IrDA compatible; and,
an encoding unit disposed between said electromagnetic receiver and said electromagnetic transmitter unit for encoding the electrical signal, said encoding unit being IrDA compatible.

5. An optical communication system according to claim 1, further including:
said electromagnetic transmitter being a laser device producing 0.1 milliwatt or greater optical output power

6. An optical communication system according to claim 5, further including:
wherein said optical communication system facilitates communication when the computing device is separated from the remote optical device by a line of sight distance of between about two meters and about 1000 meters.

7. An optical communication system according to claim 1, further including:
said electromagnetic transmitter including at least two light emitting diodes each producing 5 milliwatt or greater radiant optical output power

8. An optical communication system according to claim 7, further including:
wherein said optical communication system facilitates communication when the computing device is separated from the remote optical device by a line of sight distance of between about two meters and about 1000 meters.

9. An optical communication system according to claim 1 wherein the computing device is one of a personal data assistant, a hand holdable computer, and a mobile telephone.

10. An optical communication system according to claim 1, further including:
collimating optics cooperating with said electromagnetic transmitter for focusing said light beam;

11. An optical communication system according to claim 1, further including:
optical elements cooperating with said electromagnetic receiver for receiving the optical data signal from the remote optical device.

12. An optical communication system according to claim 11, wherein said optical elements include at least one of an optical window, gathering optics, and an optical filter.

13. An optical communication system for facilitating line of sight communication between a portable hand holdable computing device and a remote optical device, the computing device including a central processing unit, said optical communication system comprising:
(a) transmitting elements including:
(1) electromagnetic transmitter operating between any wavelength of 200 nanometers and 1500 nanometers connected to said modulator for generating a light beam containing the data generated by the central processing;
(b) receiving elements including:
(1) an electromagnetic receiver operating between any wavelength of 200 nanometers and 1500 nanometers for converting an optical data signal received from the remote optical device to an electrical signal and delivering the electrical signal to the central processing unit;
said communication system co-packaged with the computing device; and,
wherein said optical communication system facilitates communication when the computing device is separated from the remote optical device by a line of sight distance of between about two meters and about 1000 meters.

14. An optical communication system according to claim 13, further including
said electromagnetic transmitter being a laser device producing 0.1 milliwatt or greater optical output power

15. An optical communication system according to claim 13, further including:
said electromagnetic transmitter including at least two light emitting diodes, each producing 5 milliwatts or greater radiant optical output power.

16. An optical communication system according to claim 15, further including:
wherein said line of sight distance is between about two meters and about 1000 meters.

17. An optical communication system according to claim 13 wherein said computing device is one of a personal data assistant, a hand holdable computer, and a mobile telephone.

18. An optical communication system according to claim 13, further including:
collimating optics cooperating with said electromagnetic transmitter for focusing said light beam;

19. An optical communication system according to claim 13, further including:
optical elements cooperating with said electromagnetic receiver for receiving the optical data signal from the remote optical device.

20. A method of optically communicating between a computing device and a remote optical device, comprising:
providing a remote optical device;
providing the computing device including a central processing unit;
providing an optical communication system for facilitating line of sight communication between the computing device and the remote optical, said optical communication system including:
(a) transmitting elements including:
(1) a modulator connected to the central processing unit for modulating data received from the central processing unit, and (2) an electromagnetic transmitter operating between any wavelength of 200 nanometers and 1500 nanometers connected to said modulator for generating a light beam containing the data generated by the central processing unit;
(b) receiving elements including:
(1) an electromagnetic receiver operating between any wavelength of 200 nanometers and 1500 nanometers for converting an optical data signal received from the remote optical device to an electrical signal and delivering the electrical signal to the central processing unit;
activating said optical communication system, the computing device, and the remote optical device;
causing said light beam to be directed toward the remote optical device; and,
causing out going data to be sent a distance of between about two meters and about 1000 meters on said light beam from the computing device to the remote optical device via said communication system.
